(19) United States
(12) Patent Application Publication
(10) Pub. No.: US 2019/0228441 A1
(43) Pub. Date: Jul. 25, 2019

(54) Systems and Methods for Generating Product Deal Offerings

(71) Applicant: CLICK DEAL BUY! INC., Las Vegas, NV (US)

(72) Inventors: Lanny Alan Rutkin, Chicago, IL (US); Tom Karl Spitzer, Castro Valley, CA (US)

(21) Appl. No.: 16/257,210

(22) Filed: Jan. 25, 2019

Related U.S. Application Data
(60) Provisional application No. 62/621,734, filed on Jan. 25, 2018.

(51) Int. Cl. G06Q 30/02

(52) U.S. Cl. CPC G06Q 30/0276; G06Q 30/0641; G06Q 30/0211; G06Q 30/0223

(57) ABSTRACT

The system enables a potential purchaser viewing a product to easily select a deal for that product and automatically be provided with a product deal based on specifications of the product retailer, incentivizing completion of a purchase. Additionally, after a first product deal is provided to a purchaser, the purchaser may elect to receive a second product deal (different from the first product deal) and numerous other subsequent product deals, if desired.

### BACKGROUND

Online retail services have increased in popularity in recent years. In 2016, an estimated 1.61 billion people worldwide purchased goods online and global online sales amounted to more than 1.9 trillion U.S. dollars.

### SUMMARY

Although online purchases are on the rise, many would-be online purchases are not completed. For example, products placed in an online shopping cart are often abandoned, leading to low sale conversion rates. Other factors that may hinder online purchases include price sensitivity, lack of brand loyalty, and the failure of some online retailers to competitively price goods. At this time, the market demands innovative methods and systems of pricing goods to effectively convert online retailing activities into product sales. As described in detail below, the disclosed systems and methods enable a potential purchaser viewing a product to easily select a deal for that product and automatically be provided with a product deal based on specifications of the product retailer. Additionally, after a first product deal is provided to a purchaser, the purchaser may elect to receive a second product deal (different from the first product deal) and numerous other subsequent product deals, if desired.

### BRIEF DESCRIPTION OF THE DRAWINGS

FIG. 1 shows a diagram of an exemplary system for providing product deal offerings, in accordance with some embodiments of the subject disclosure.

FIG. 2 shows an exemplary user interface displaying a selected product and a deal button, in accordance with some embodiments of the subject disclosure.

FIG. 3 shows an exemplary user interface displaying a product deal offering, in accordance with some embodiments of the subject disclosure.

FIGS. 4A and 4B show exemplary user interfaces displaying deal selection features in accordance with some embodiments of the subject disclosure.

FIGS. 5A-5C show exemplary user interfaces displaying deal rules, in accordance with some embodiments of the subject disclosure.

FIGS. 6A-6I show exemplary reports which may be generated by the disclosed systems, in accordance with some example embodiments of the subject disclosure.

FIG. 7 shows a flow diagram of an exemplary method of providing product deal offerings, in accordance with some embodiments of the subject disclosure.

FIG. 8 shows an exemplary computer system which may be used in connection with some example embodiments of the subject disclosure.

### DETAILED DESCRIPTION

Systems and methods for providing product deal offerings are described herein. As used herein, the term “product” refers to any type of asset, including both goods and services. In particular, systems for providing a purchaser or potential purchaser with a plurality of deals that include one or more products or services are described. The disclosed systems are capable of interfacing with product retailers (for example, via a product retailer website) to allow a purchaser to select one or more products from the retail site for a product deal. After receiving a product deal request from a user, the proprietary cloud computing platform described herein generates a product deal offering by applying a set of rules selected by a retailer. The product deal offering is then sent to the purchaser (i.e., onto a graphical user interface of the purchaser's mobile computing device) and the purchaser can view the product deal offering. In certain embodiments, the product deal offering is a product bundle that includes the selected product and one or more related products. In some cases, the product deal offering is temporary and expires after a predetermined period of time. In some embodiments, the purchaser may either select the product deal offering displayed or may request a different product deal offering. If the purchaser requests a different product deal offering, the cloud computing platform described in detail below may generate a new product deal offering and send the new product deal offering to the purchaser.

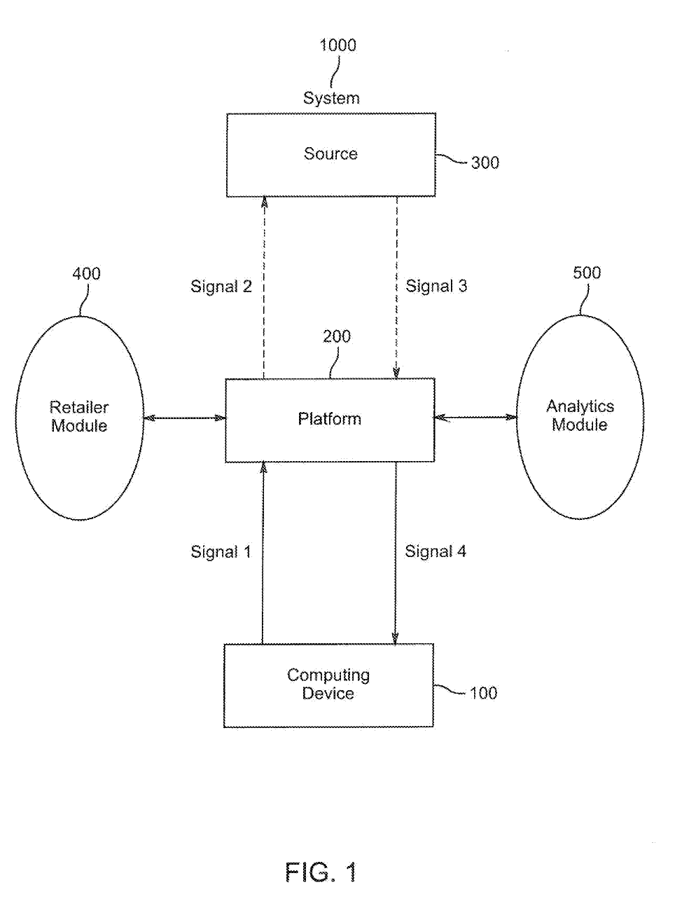

FIG. 1 is an exemplary diagram illustrating a system 1000 having a computing device 100, a platform 200 configured to execute one or more of the disclosed methods, and an external source 300. Computing device 100 shown in FIG. 1 may be any type of computing device, such as a mobile computing device (e.g., a cell phone, laptop computer, or tablet) and may, in some cases, include processing capabilities, memory, and a graphical user interface. Computing device 100 may include software or an application specifically designed to interface with platform 200 or, in some cases, a retailer's website may include software to interface with platform 200 and computing device 100 may not include software (for example, an app) specifically designed to provide access to platform 200.

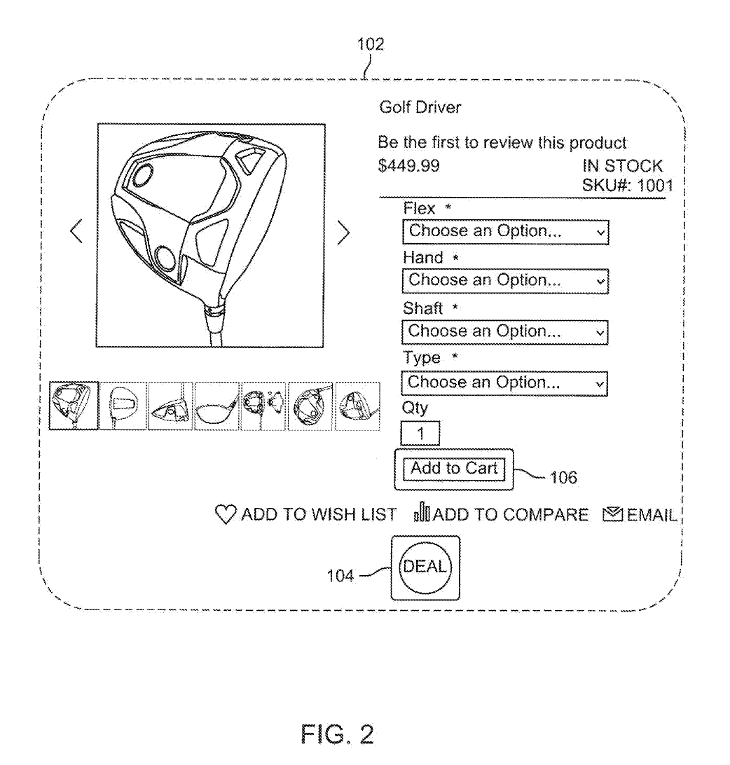

As shown in FIG. 1, computing device 100 may be configured to transmit a signal (e.g., Signal 1) to platform 200. In some embodiments, Signal 1 transmitted to platform 200 from computing device 100 includes data pertaining to a selected product. For example, if a purchaser is viewing a product on a retailer's website or a different website, such as a separate deal website, the purchaser may request a deal for a selected product. In some cases, a purchaser may select a deal by clicking on a deal button of a user interface. An example user interface 102 with a deal button 104 is shown in FIG. 2. As shown in FIG. 2, in some embodiments, a deal button 104 may appear adjacent to or near an ‘add to cart’ button 106 or a ‘purchase’ button. As is known in the prior art, engaging the ‘add to cart’ button 106 will add the product shown on the interface 102 to a file containing items to be purchased (referred to as the ‘cart’ in ecommerce jargon) for the price indicated on the interface ($449.99 in FIG. 2). Although deal button 104 is shown on a product description page in FIG. 2, in some embodiments, a deal button 104 may be accessible when viewing one or more products placed in an ecommerce shopping cart. When deal button 104 is engaged, computing device 100 may transmit Signal 1 containing data pertaining to a selected product to platform 200. In some embodiments, Signal 1 includes a unique internal identifier, a product stock-keeping unit (SKU), a manufacturer's suggested retail price (MSRP), product name, and/or other information pertaining to the selected product. The deal button 104 may present an option for purchasing the product on interface 102 that is distinct from adding the item to the cart for the $449.99 price indicated on the interface. The option presented by the deal button 104 may incentivize completion of the purchase without departing from the site.

As shown in FIG. 1, platform 200 may be configured to receive a signal (for example, Signal 1) from computing device 100. In some cases, platform 200 is implemented with a cloud computing platform, a server, network, or other processing device. After receiving Signal 1, which includes data pertaining to a selected product, from computing device 100, platform 200 may generate a product deal for the selected product. In some embodiments, platform 200 generates a product deal by applying one or more pre-determined rules to the selected product. For example, in some cases, a retailer may identify some products as excess inventory and may configure platform 200 to apply a discount (e.g., a fixed percentage discount or a fixed dollar amount discount) to excess inventory products. In some embodiments, the pre-determined rule applied to the selected product may be to provide an aggregated or a bundled product offering, which includes the selected product and one or more additional related products. In some such embodiments, the generated deal may be a bundled product offering having an overall discounted price for all included items.

In some cases, platform 200 may generate a product deal without consulting an external source, while in other embodiments, platform 200 may transmit a signal to an external source, receive a signal from the external source, and use the data contained in the received signal to generate a product deal. FIG. 1 illustrates an example embodiment in which platform 200 transmits a signal (Signal 2) to an external source 300 containing data pertaining to a potential product deal. For example, if a retailer would like to provide a product at a price point lower than a competitor's price, platform 200 may be configured to transmit a signal (Signal 2 in FIG. 1) requesting a competitor's price for the selected product. Source 300, which may be external to platform 200 and computing device 100, may receive Signal 2 from platform 200 and compile the requested information. Source 300 may be a website, server, database, or other component. After compiling the requested information, source 300 may transmit a signal (Signal 3 in FIG. 1) to platform 200 containing data pertaining to a potential product deal. In the example in which a competitor's price for a selected product has been requested from platform 200, source 300 may compile the competitor's price for the selected product and transmit a signal (Signal 3 in FIG. 1) containing the competitor's price to platform 200.

In some embodiments, system 1000 may be configured to periodically retrieve pricing information from one or more sources 300. For example, platform 200 may be configured to obtain pricing information for various products from one or more sources (e.g., retailer websites). In these and other embodiments, the retrieved pricing information may be stored in a database which may be accessed by platform 200. In some such embodiments, platform 200 may access the database and use the stored pricing information previously retrieved from one or more sources 300 to generate product deal offerings.

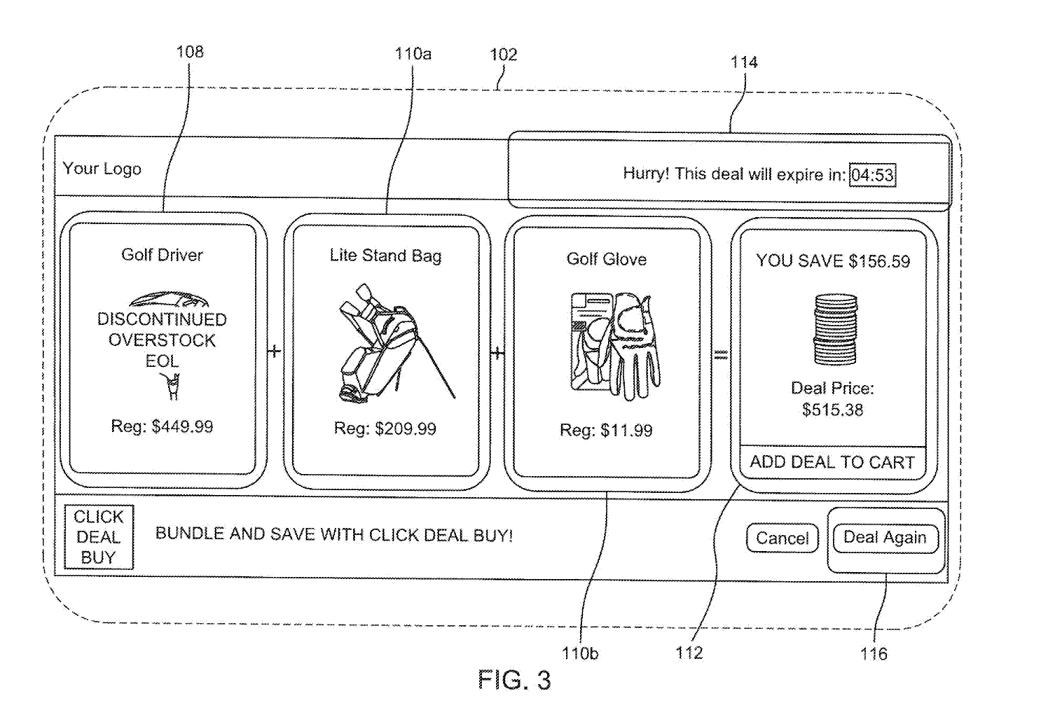

In some embodiments in which an external source 300 is used, platform 200 may receive a signal (Signal 3 in FIG. 1) from the source 300. Once all pertinent data has been transmitted to platform 200, platform 200 can generate a product deal. As previously described, in some embodiments, the product deal generated may include a bundled product offering. An example of a user interface 102 displaying a bundled product offering is shown in FIG. 3. As shown in FIG. 3, the bundled product offering may include the selected product 108 and one or more related products (110a and 110b in FIG. 3) as well as a discount illustration 112. Related products for a bundled product offering may be selected by any suitable mechanism, including but not limited to products recently searched or viewed. In some embodiments, a deal timer 114 may be shown on the user interface 102 to indicate an amount of time in which the deal will expire. Additionally, the user interface 102 may also include a deal again button 116 to allow a user to request a new product deal. If a deal again button 116 is included in user interface 102, selection of the deal again button 116 may result in a signal being sent from computing device 100 to platform 200, platform 200 generating a new product deal, and the new product deal being transmitted to and received by computing device 100. In some embodiments, when deal again button 116 is activated, deal timer 114 may restart.

In some embodiments, the disclosed system 1000 may also include a retailer module 400 and/or an analytics module 500, as shown in FIG. 1. Retailer module 400 and analytics module 500 may be implemented with any appropriate hardware and software, including but not limited to computing devices, servers, and processors. If present, retailer module 400 may be configured to transmit signal to and receive signal from platform 200. In some embodiments, retailer module 400 may be used by a product retailer to specify how platform 200 should generate product deal offerings. For example, if a retailer would like to prioritize selling a particular product, the retailer may access retailer module 400 and transmit instructions to platform 200 to generate product offerings for that product to incentivize purchasers to buy the product. For example, the retailer may elect to apply a 50% discount to a product or may instruct platform 200 to apply another deal designed to motivate purchasers to purchase the product.

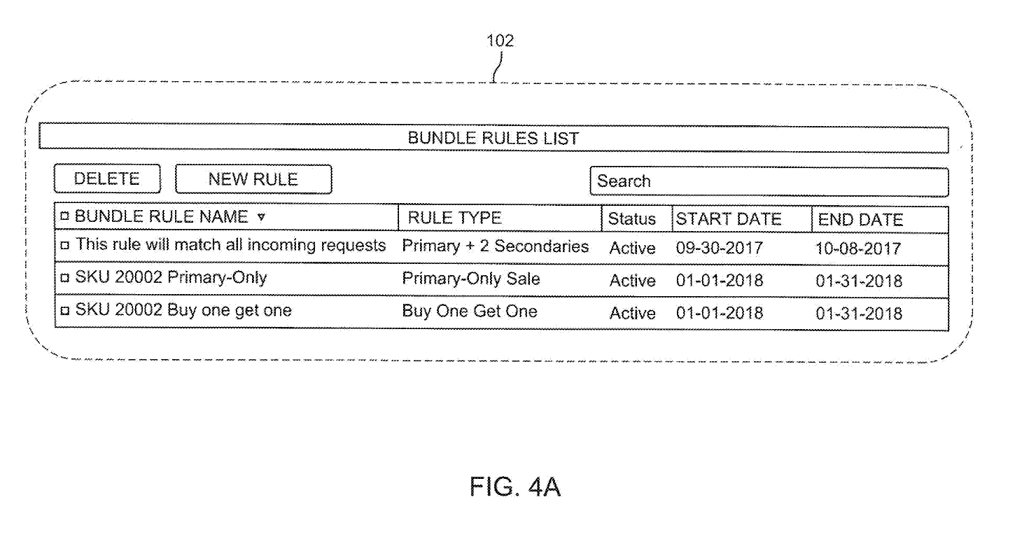

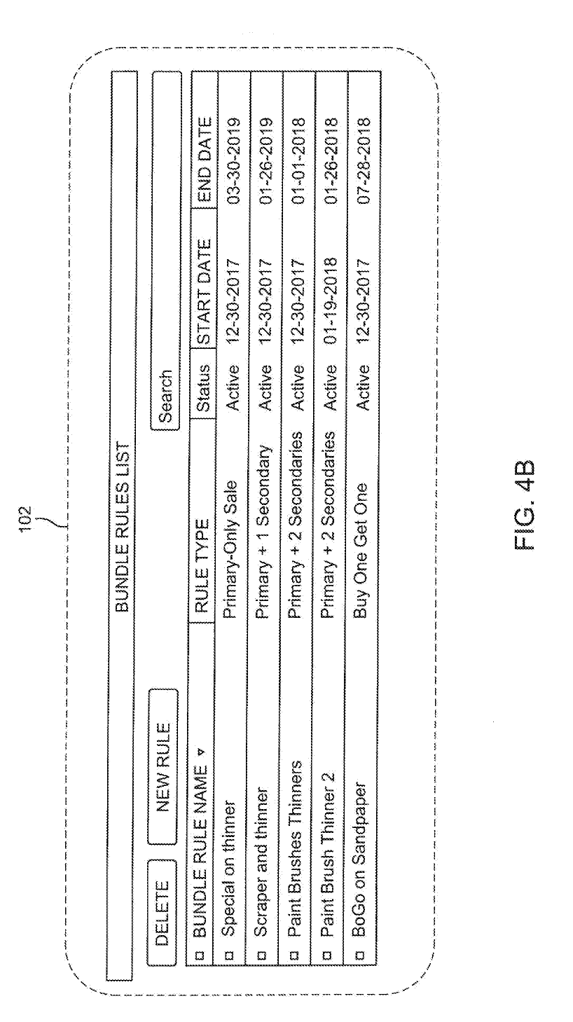

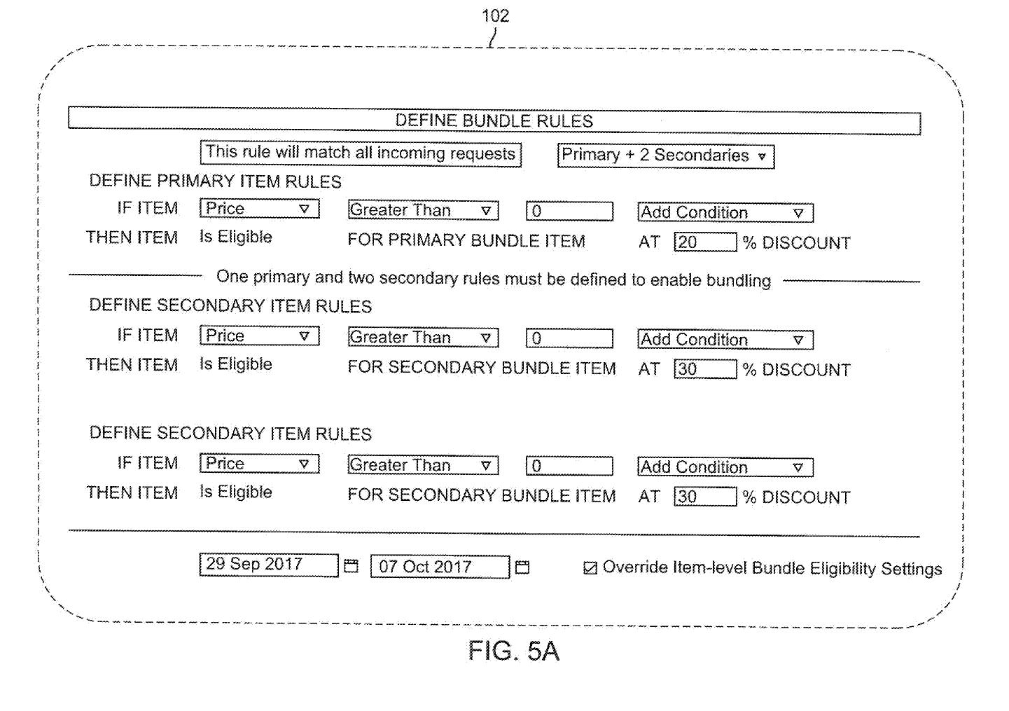

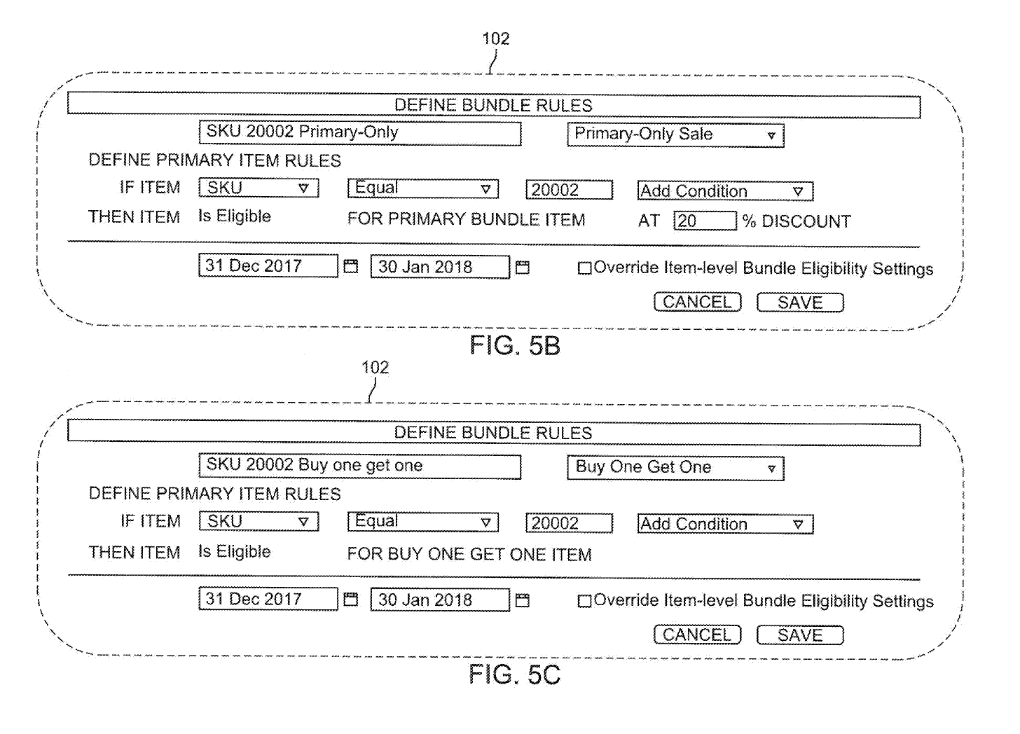

In some embodiments, retailer module 400 includes a deal selection feature in which one or more deals can be selected for application by platform 200. FIGS. 4A and 4B show example user interfaces 102, each displaying a deal selection feature in which various deals can be selected. In some embodiments, a deal may be customized and/or created in retailer module 400. FIGS. 5A-5C show user interfaces 102 displaying deal rules. In particular, the deal rules shown in FIG. 5A specify that the deal will include the selected product and two secondary products, the selected product (also referred to as the primary product) will be given a 20% discount, and the two secondary products will each be given a discount of 30%. The deal rules shown in FIG. 5B specify that the deal will include only the primary product and will apply a 20% discount. The deal rules shown in FIG. 5C specify that the primary product will be bundled with one additional primary product and that the additional primary product will be free. Numerous variations and configurations for deal rules are contemplated and within the scope of the subject disclosure.

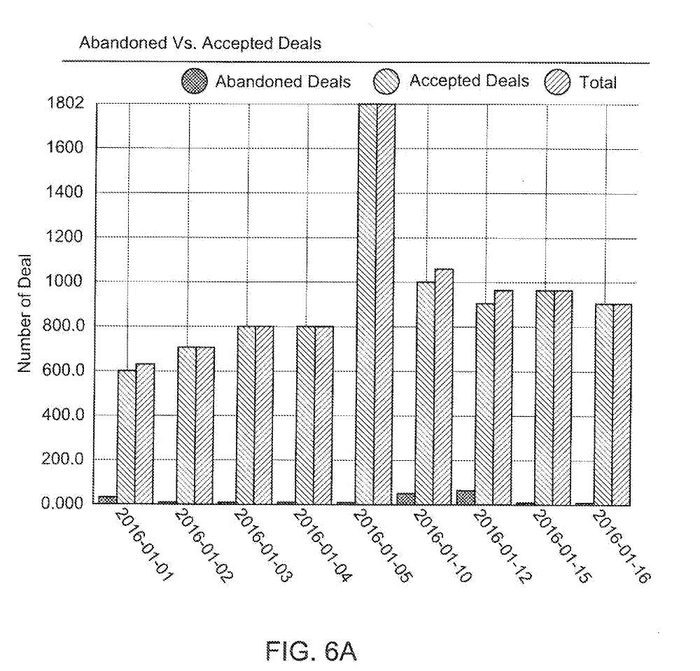

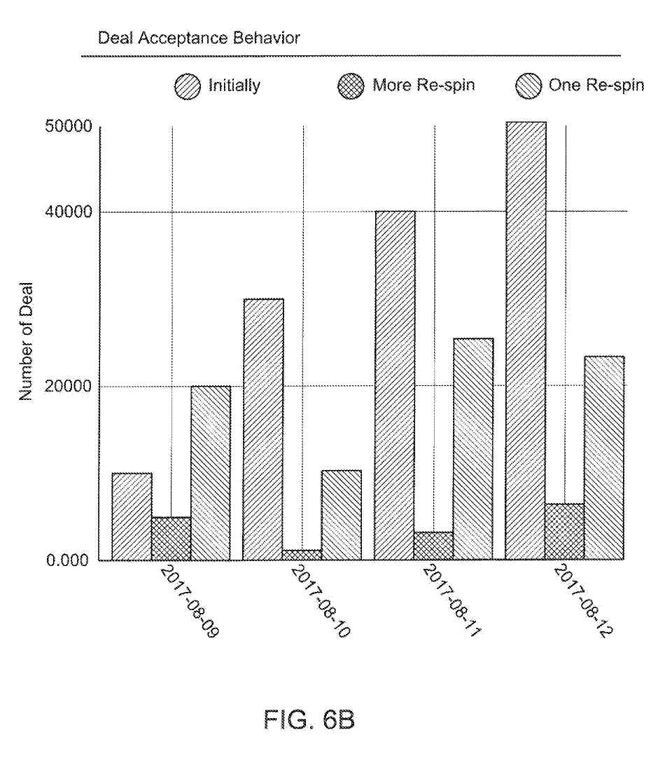

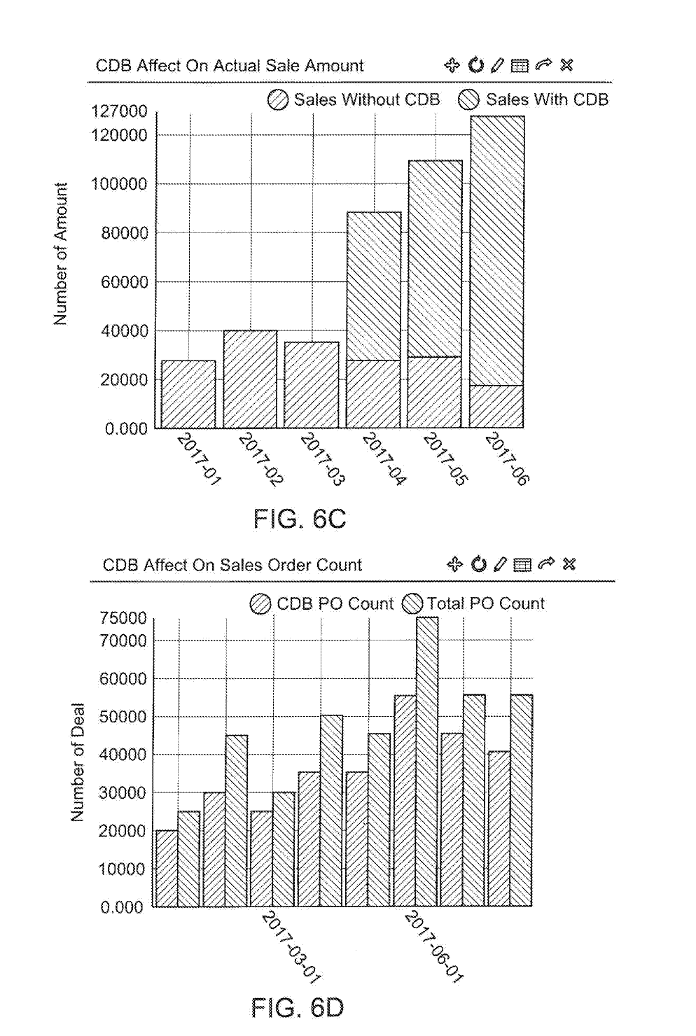

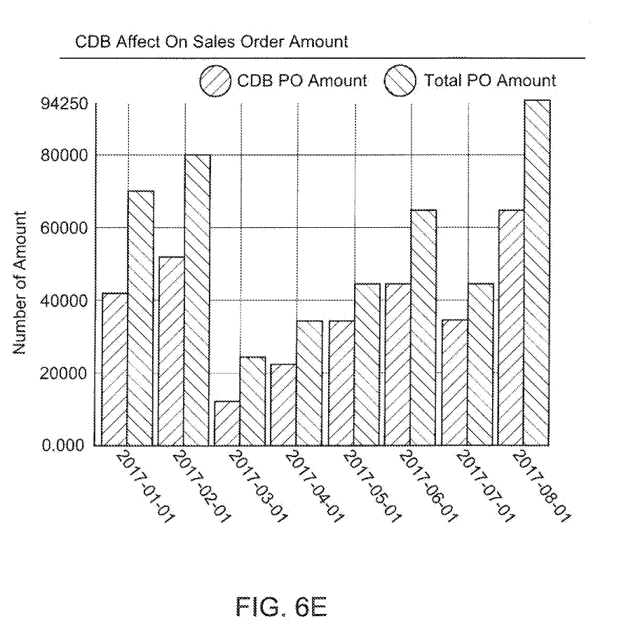

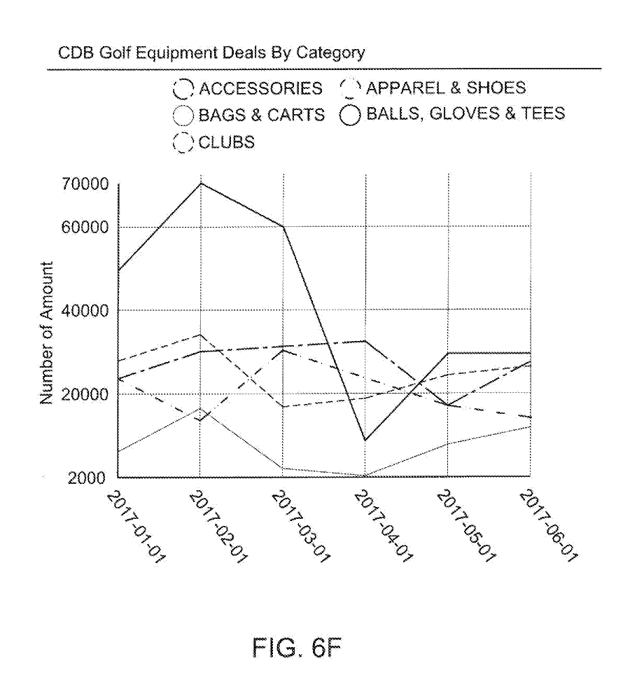

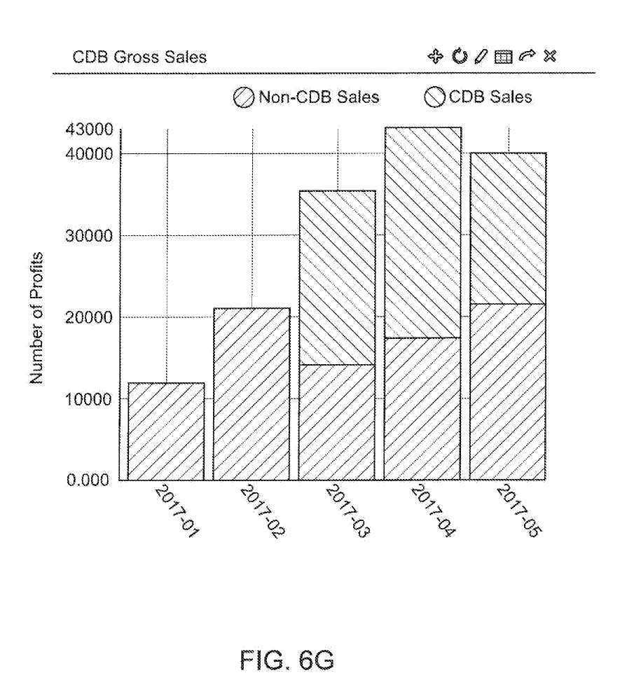

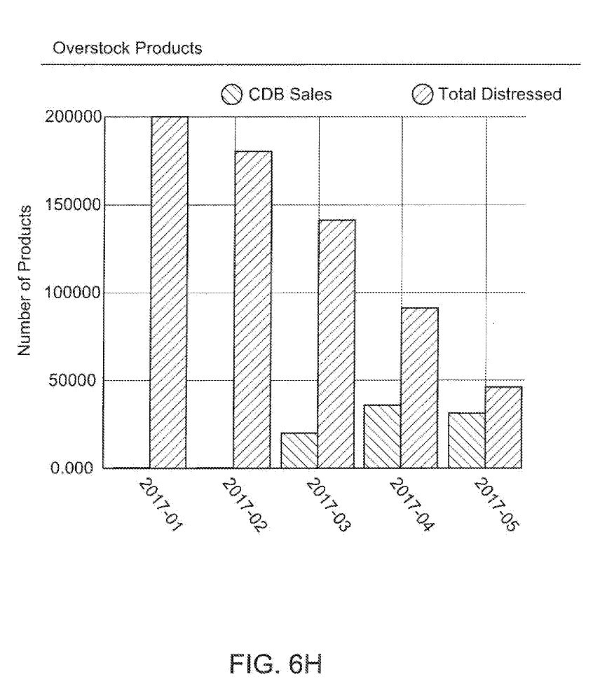

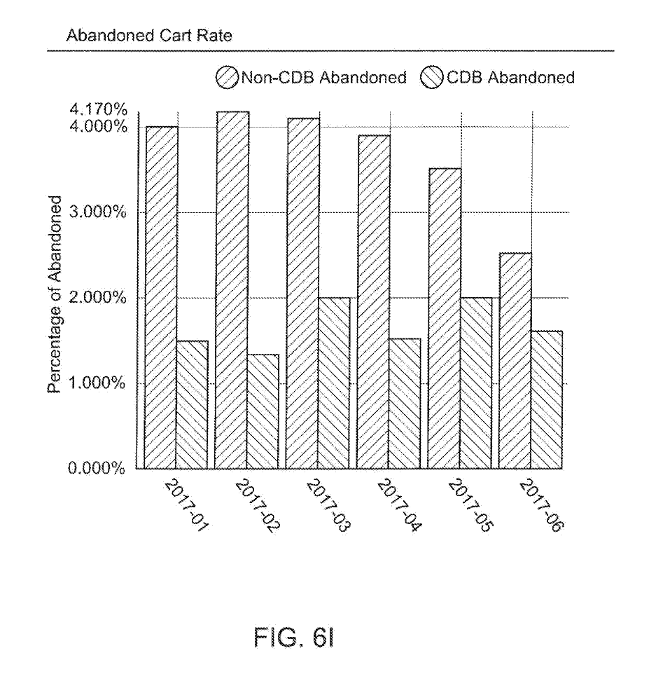

If present, analytics module 500 may be configured to transmit signal to and receive signal from platform 200. Analytics module 500 may, in some cases, be accessed by a system administrator and can be configured to generate a number of reports from the data contained within platform 200. For example, reports generated by analytics module 500 may be used to evaluate the success of a particular product deal strategy implemented by platform 200 by applying the selected rules. The analytical reporting of analytics module 500 may provide insight into sale conversion rates, product popularity, purchaser behavior, and other relevant information. In some embodiments, analytics module 500 is configured to automatically evaluate a particular deal offered to purchasers and uses machine learning techniques to recommend and/or implement deal rules to improve product sales. In some embodiments, the analytics module 500 may use artificial intelligence and/or machine learning to recommend a price for a selected product or bundled product offering, wherein the recommended price is designed to sell the selected product based on statistics gathered by the analytics module 500. As will be understood, the disclosed systems may offer deal optimization, price optimization, excess inventory control, as well as an engaging, responsive, and interactive user interface. Analytics module 500 may also enable numerous reports to be generated, capturing the efficiency of the deals produced. FIGS. 6A-6I show example reports which may be generated by analytics module 500, in some example embodiments.

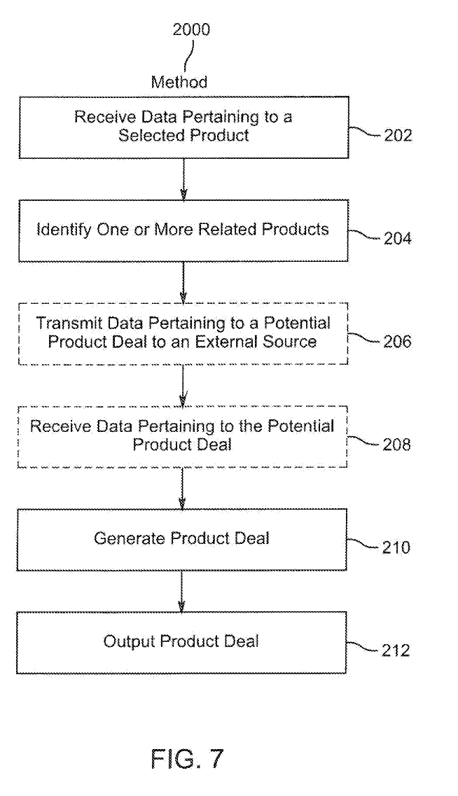

FIG. 7 is a flow diagram showing an example method 2000 that may be carried out by platform 200 to generate one or more product deal offerings, in accordance with embodiments of the present disclosure. As shown in FIG. 7, platform 200 may receive 202 data pertaining to a selected product (for example, in the form of Signal 1). Upon receiving data pertaining to a selected product, platform 200 may identify 204 one or more related products. For example, if a dog collar is the selected product, platform 200 may identify a dog leash, a dog toy, and/or a dog treat as related products. After identifying one or more related products, platform 200 may optionally transmit 206 data pertaining to a potential product deal to an external source. For example, if a retailer would like to ensure its product deal offerings are less expensive than a competitor's product, platform 200 may be configured to transmit data pertaining to a potential product deal to the competitor's website to determine the competitor's price for the selected product. Platform 200 may then optionally receive 208 data transmitted from the external source pertaining to the potential product deal. In some embodiments, the data transmitted 206 to the external source may be the selected product and the data received 208 from the external source may be the competitor's price for the selected product.

Method 2000 continues with platform 200 generating 210 a product deal and outputting 212 the product deal (for example, to computing device 100). A product deal can be generated 210 by applying one or more rules selected by a retailer (for example, by using retailer module 400). In some embodiments, rules applied to generate product deals may be created to incentivize in-store purchases as opposed to online purchases. In some embodiments, rules may be designed to apply a certain percentage discount (for example 5%, 10% or more). In some embodiments, rules may be applied to beat a competitor's price by a certain dollar amount or percentage.

In some respects, the disclosed systems may operate as a SaaS platform for e-commerce. Particularly, the disclosed systems and methods may provide personalized e-commerce by assembling product deal offerings based on a retailer's priorities (for example, selling excess product inventory, prioritizing sales of particular products, and/or selling at strategic price points). The disclosed methods and systems may be used in connection with products and/or services in B2B as well as B2C industries. In some cases, the disclosed methods may be implemented as a consumer subscription service. For example, in some cases, consumers may subscribe to access product deal offerings generated by platform 200 for a period of time (e.g., one day, one week, one month, one year, or longer).

The disclosed methods are scalable, global, and sustainable. The disclosed proprietary systems create deals for any goods or services bought or sold worldwide, helping businesses to sell more without sacrificing profits or raises and increasing shopping cart conversion rates, and even driving customers into brick and mortar stores, if desired. As will be understood, the disclosed systems may be adapted to interface with any type of retailer, including online retailers and e-commerce websites. Retailers utilizing the disclosed systems may gain advantageous insight into consumer preferences and behaviors, which may lead to increased profitability and more satisfied customers.

In some embodiments, the disclosed methods and systems may provide a platform for users to receive a product deal offering while present at a retail location. In some such embodiments, a user may select a product while at the retail location (which may be identified with a particular marking to indicate the product is eligible for a deal offering) and request a product deal offering. In some embodiments, the user may request a product deal offering by scanning a bar code or QR code of the product using a mobile computing device or scanner. The user may then choose to select the product deal offering displayed or request a new product deal offering. If the user elects to proceed with selecting a product deal offering, the user may proceed with completing the purchase (either through an application on the mobile computing device or at a check out register of the retailer) and leave the retail location with the purchased product(s). In select embodiments, after a product deal offering is generated, a unique identifying code (for example, a barcode or QR code) may be generated and/or displayed. In embodiments where a product deal offering purchase is made at a retail location using a check out register, the unique identifying code generated may be scanned to complete the check out process at the retail location. Numerous configurations and variations are possible and contemplated.

While the disclosed systems may be used on a mobile computing device outside of a retailer's brick and mortar location, in some circumstances, the disclosed systems may be configured to provide specific deals to purchasers based on location. For example, a purchaser may be able to request a deal at a participating retail location and receive a product deal while present at the retail location.

In some example embodiments, a consumer may register directly with an entity, for example, Click Deal Buy! Inc., to be eligible to request product deal offerings, as described herein. In some such embodiments, the consumer may need to provide personal information when registering and pay a subscription fee for usage of the provided services during a defined time period (for example, one year). In these and other embodiments, when the consumer logs into their account, they may select whether the purchased product(s) will be delivered or picked up at the retailer's location. In some embodiments, different product deal offerings may be generated based on whether the purchase is identified as for delivery or pick-up.

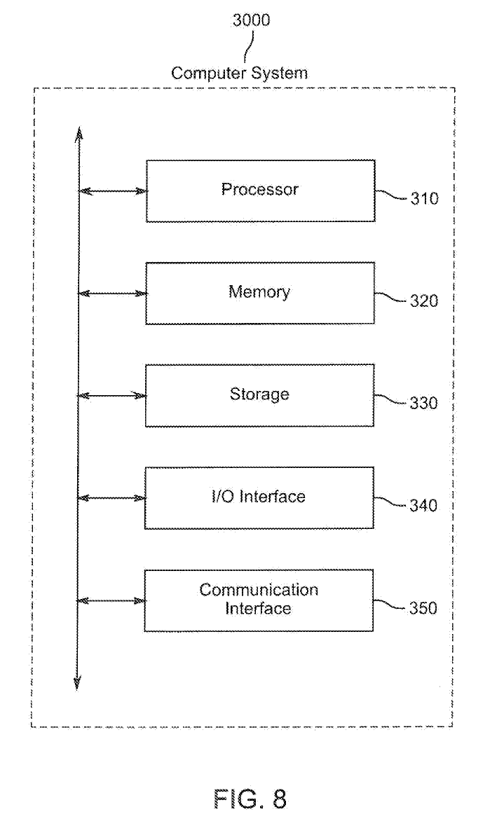

FIG. 8 illustrates an example computer system 3000 that may be used in some embodiments to perform some or all steps of the disclosed methods. This disclosure contemplates any suitable number of computer systems 3000. In some embodiments, computer system 3000 includes a processor 310, memory 320, storage 330, an input/output (I/O) interface 340, and/or a communication interface 350. In particular embodiments, processor 310 includes hardware for executing instructions, such as those making up a computer program. As an example and not by way of limitation, to execute instructions, processor 310 may retrieve (or fetch) instructions from an internal register, an internal cache, memory 320, or storage 330; decode and execute the instructions; and then write one or more results to an internal register, an internal cache, memory 320, or storage 330. In particular embodiments, processor 310 may include one or more internal caches for data, instructions, and/or addresses.

In particular embodiments, memory 320 includes main memory for storing instructions for processor 310 to execute or data for processor 310 to operate on. As an example and not by way of limitation, computer system 3000 may load instructions from storage 330 or another source (such as, for example, another computer system 3000, source 300, or retailer module 400) to memory 320. Processor 310 may then load the instructions from memory 320 to an internal register or internal cache. To execute the instructions, processor 310 may retrieve the instructions from the internal register or internal cache and decode the instructions. During or after execution of the instructions, processor 310 may write one or more results (which may be intermediate or final results) to the internal register or internal cache. Processor 310 may then write one or more of those results to memory 320. One or more memory buses (which may each include an address bus and a data bus) may couple processor 310 to memory 320. If present, a bus may include one or more memory buses. In particular embodiments, one or more memory management units (MMUs) reside between processor 310 and memory 320 to facilitate accesses to memory 320 requested by processor 310. In particular embodiments, memory 320 includes random access memory (RAM). This RAM may be volatile memory, when appropriate. In some circumstances, when appropriate, this RAM may be dynamic RAM (DRAM) or static RAM (SRAM). In some embodiments, memory 320 may encompass one or more storage media and may, generally, provide a place to store computer code (e.g., software or firmware) and data that is used by a computing platform (for example, platform 200). By way of example, memory 320 may, in some embodiments, include various tangible computer-readable storage media including Read-Only Memory (ROM) or Random-Access Memory (RAM).

In particular embodiments, storage 330 includes mass storage for data or instructions. As an example and not by way of limitation, storage 330 may include an HDD, a floppy disk drive, flash memory, an optical disc, a magneto-optical disc, magnetic tape, or a Universal Serial Bus (USB) drive or a combination of two or more of these. When appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, interface 340 includes hardware, software, or both providing one or more interfaces for communication between computer system 3000 and one or more I/O devices (for example, computing device 100). Computer system 3000 may include one or more of these I/O devices, when appropriate. One or more of these I/O devices may enable communication between a user and computer system 3000. When appropriate, I/O interface 340 may include one or more device or software drivers enabling processor 310 to drive one or more of these I/O devices. I/O interface 340 may include one or more I/O interfaces 340, when appropriate.

In particular embodiments, communication interface 350 includes hardware, software, or both providing one or more interfaces for communication (such as, for example, packet-based communication) between computer system 3000 and one or more other computer systems 3000 or one or more networks. As an example and not by way of limitation, communication interface 350 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 350 for it.

As will be understood, in some cases a specific performance device, as opposed to a general purpose computer, may be employed to perform the disclosed methods. Furthermore, in some example embodiments, the disclosed systems include one or more computer-readable non-transitory storage media embodying software that is operable when executed to perform any of the disclosed methods. The disclosed methods and systems, may, in some example embodiments, improve the employed hardware and/or software.

The features and advantages described herein are not all-inclusive and, in particular, many additional features and advantages will be apparent to one of ordinary skill in the art. Moreover, it should be noted that the language used in the specification has been selected principally for readability and instructional purposes, and not to limit the scope of the inventive subject matter described herein. The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

What is claimed is:

1. A system for providing a purchaser or potential purchaser with a plurality of deals related to at least one product or service, the system comprising:
a computing device adapted to access instructions designed to cause the computing device to interface with a platform, the computing device further adapted to transmit data pertaining to the at least one product or service to the platform;
the platform adapted to receive the signal from the computing device, the platform further adapted to applying a set of predetermined rules to the data to generate a product deal, the platform further adapted to transmit the product deal to the computing device.

2. The system of claim 1, wherein the predetermined rules include at least one of discounts for excess inventory products and bundled product offerings.

3. The system of claim 1, wherein the platform is adapted to transmit a signal related to the data to an external source and to receive external source data from the external source, the platform utilizing the external source data and the data pertaining to the at least one product or service to generate a product deal.

4. The system of claim 1, wherein the platform generates a plurality of product deals, and transmits the plurality of product deals to the computing device.

5. The system of claim 1 further comprising an analytics module in operative communication with the platform, the analytics module configured to evaluate the success of a product deal strategy generated by the platform.

6. A method for providing a purchaser or potential purchaser with a plurality of deals related to at least one product or service, the method comprising:
a computing device receiving a selection pertaining to the at least one product or service;
the computing device interfacing with a platform, and transmitting a signal comprising data pertaining to the at least one product or service to the platform;
the platform receiving the signal from the computing device;
the platform applying a set of predetermined rules to the data to generate a product deal; and
the platform transmitting the product deal to the computing device.

7. The method of claim 6, wherein the predetermined rules include at least one of discounts for excess inventory products and bundled product offerings.

8. The method of claim 6, further comprising the platform transmitting a signal related to the data to an external source and receiving external source data from the external source, the platform generating a product deal based on the external source data and the data pertaining to the at least one product or service.

9. The method of claim 6, the platform generating a plurality of product deals, and transmitting the plurality of product deals to the computing device.

10. The method of claim 6 further comprising the platform communicating data related to a product deal strategy generated by the platform to an analytics module, and the analytics module evaluating the success of the product deal strategy.
